(19) United States
(12) Patent Application Publication
(10) Pub. No.: US 2013/0229345 A1
(43) Pub. Date: Sep. 5, 2013

(54) Manual Manipulation of Onscreen Objects

(71) Applicants: Laura E. Day, San Francisco, CA (US); Yosi Govezensky, Nofit (IL); Craig A. HURST, Hillsboro, OR (US); Ratko Jagodic, Santa Clara, CA (US); Deepti Joshi, Hillsboro, OR (US); Rajiv K. Mongia, Redwood City, CA (US); Garth Shoemaker, Sunnyvale, CA (US)

(72) Inventors: Laura E. Day, San Francisco, CA (US); Yosi Govezensky, Nofit (IL); Craig A. HURST, Hillsboro, OR (US); Ratko Jagodic, Santa Clara, CA (US); Deepti Joshi, Hillsboro, OR (US); Rajiv K. Mongia, Redwood City, CA (US); Garth Shoemaker, Sunnyvale, CA (US)

(21) Appl. No.: 13/607,938

(22) Filed: Sep. 10, 2012

Related U.S. Application Data
(60) Provisional application No. 61/605,414, filed on Mar. 1, 2012.

(51) Int. Cl. G06F 3/033

(52) U.S. Cl. 345/158

(57) ABSTRACT

According to some embodiments, hand gestures may be entirely used to control the apparent action of objects on a display screen. As used herein, using “only” hand gestures means that no physical object need be grasped by the user's hand in order to provide the hand gesture commands. As used herein, the term “hand-shaped cursor” means a movable hand-like image that can be made to appear to engage or grasp objects depicted on a display screen. In contrast a normal arrow cursor cannot engage objects on a display screen.

### CROSS-REFERENCE TO RELATED APPLICATIONS

This application is a non-provisional application claiming priority to provisional application Ser. No. 61/605,414, filed on Mar. 1, 2012, hereby expressly incorporated by reference herein.

### BACKGROUND

This relates generally to the control of images on computer displays.

Typically, manipulation of images on computer displays is accomplished using either a mouse to move a cursor image around or by using the mouse cursor to select and move various objects. One drawback to this approach is that the user must have a mouse. Another drawback is that the user must use the mouse to manipulate the objects. More versatile joysticks may also be used in a similar way but all these techniques have the common characteristic that the user must manipulate a physical object in order to manipulate what happens on the display screen.

### BRIEF DESCRIPTION OF THE DRAWINGS

Some embodiments are described with respect to the following figures:

FIG. 1 is a depiction of a user hand gesture to begin to grasp an object according to one embodiment;

FIG. 2 is a depiction of a user gesture to complete grasping of an object according to one embodiment to the present invention;

FIG. 3 is a depiction of a user hand gesture to begin to move an object according to one embodiment;

FIG. 4 is a depiction of a user hand gesture to complete the movement of an object according to one embodiment;

FIG. 5 is a depiction of a user hand gesture to begin rotation of an object according to one embodiment;

FIG. 6 is a depiction of a user gesture to complete movement of an object after having completed the gesture according to one embodiment;

FIG. 7 is a depiction of a user hand gesture to begin to resize an object at the beginning of the gesture according to one embodiment;

FIG. 8 is a depiction of a user hand gesture to complete the resizing of an object at the end of the gesture according to one embodiment;

FIG. 9 is a depiction of a user hand gesture to indicate a screen location according to one embodiment;

FIG. 10 is a depiction of a user gesture to begin changing the apparent camera position according to one embodiment of the present invention;

FIG. 11 is a depiction of a user hand gesture to perform a panning of a virtual camera according to one embodiment;

FIG. 12 is a depiction of a user hand gesture in accordance with a panning command according to one embodiment;

FIG. 13 is a depiction of a display screen according to one embodiment of the present invention where a hand-shaped cursor is being moved to grasp an object according to one embodiment;

FIG. 14 is a depiction corresponding to FIG. 13 after the hand shaped cursor has been moved to a position to interface with the object according to one embodiment;

FIG. 15 is a screen display after the hand-shaped cursor has actually moved and rotated the object according to one embodiment;

FIG. 16 is a flow chart for local gesture control according to one embodiment to the present invention;

FIG. 17 is a flow chart for a system that enables the virtual camera orientation to be altered according to one embodiment; and

FIG. 18 is a schematic depiction of one embodiment of the present invention.

### DETAILED DESCRIPTION

According to some embodiments, hand gestures may be entirely used to control the apparent action of objects on a display screen. As used herein, using “only” hand gestures means that no physical object need be grasped by the user's hand in order to provide the hand gesture commands. As used herein, the term “hand-shaped cursor” means a movable hand-like image that can be made to appear to engage or grasp objects depicted on a display screen. In contrast a normal cursor cannot engage objects on a display screen.

In some embodiments, three-dimensional mid-air hand gestures may be used to manipulate depicted objects in three-dimensions.

In some embodiments, the hand-shaped cursor may be moved, using only hand gestures, to interact with display screen depicted objects. Then those depicted objects may be moved in a variety of ways only using hand gestures.

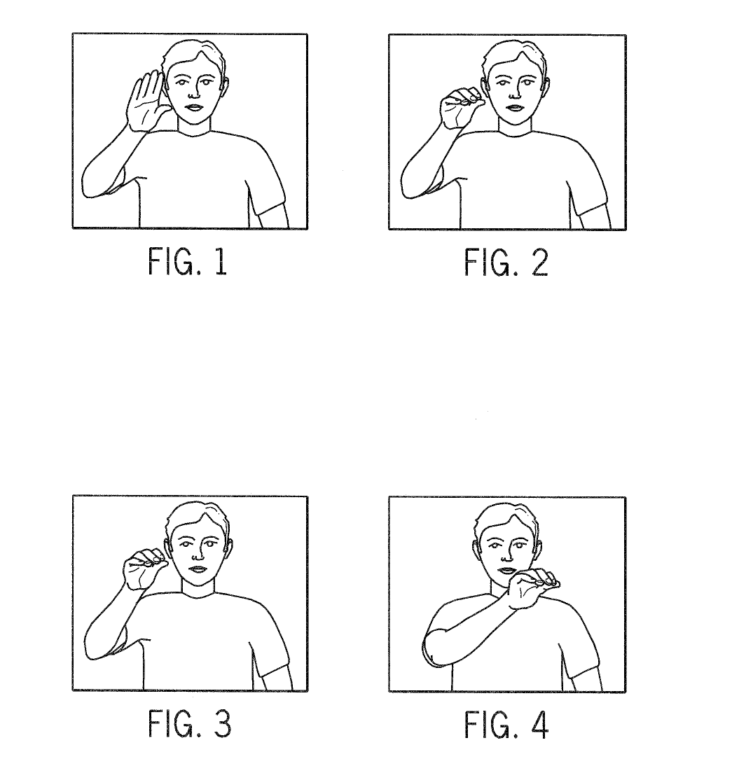

Referring to FIG. 1, a user is shown in position about to grasp an object. In this position, the hand shaped cursor may already have been moved to visually interact with the object. Then when the user closes the user's hand as indicated in FIG. 2, the hand-shaped cursor physically engages, as if grasping, the object depicted on the screen.

The cursor may also take other shapes in some embodiments. For example, it may be a rigged geometric model of a hand, a traditional cursor, or a glowing ball to mention some examples.

The display screen is associated with a processor-based device. That device is coupled to image capture devices, such as video cameras, that record the user's motion. Then video analytics applications executing on that device may analyze the video. That analysis may include recognition of hand poses, motion or positions. A pose means a hand configuration defined by angles at joints. Motion means translation through space. Position means location in space. The recognized hand positions may then be matched to stored hand positions linked to particular commands. One or more cameras image the user's action and coordinate that user action to the depiction of the appropriately position hand-shaped cursor. In some embodiments the hand-shaped cursor has fingers that appear to move in a way that corresponds to a hand grasping the object.

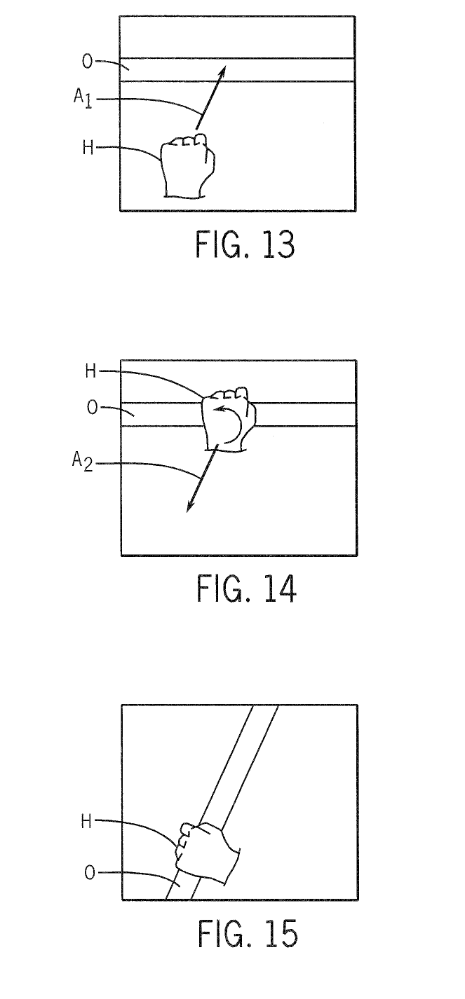

Particularly, as shown in FIG. 13, the hand-shaped cursor H may be caused to move in the direction indicated by the arrow A1 to engage the stick shaped object O. This may be done by only using hand gestures. As shown in FIG. 14, once the hand-shaped cursor is in association with the object O, movement of the hand-shaped cursor in an counterclockwise rotation results in rotation of the objection O as shown in FIG. 15. The rotation of the hand-shaped object may be the result of the user providing a rotation command, by virtue of the hand gestures that are captured by appropriate cameras.

In one embodiment the hand shaped cursor object may change shape. For example the “fingers” may open to engage an object and then close to grasp that object.

While a simple rotary motion is depicted, virtually any type of motion in two or three dimensional space can be commanded in the same way using only hand gestures.

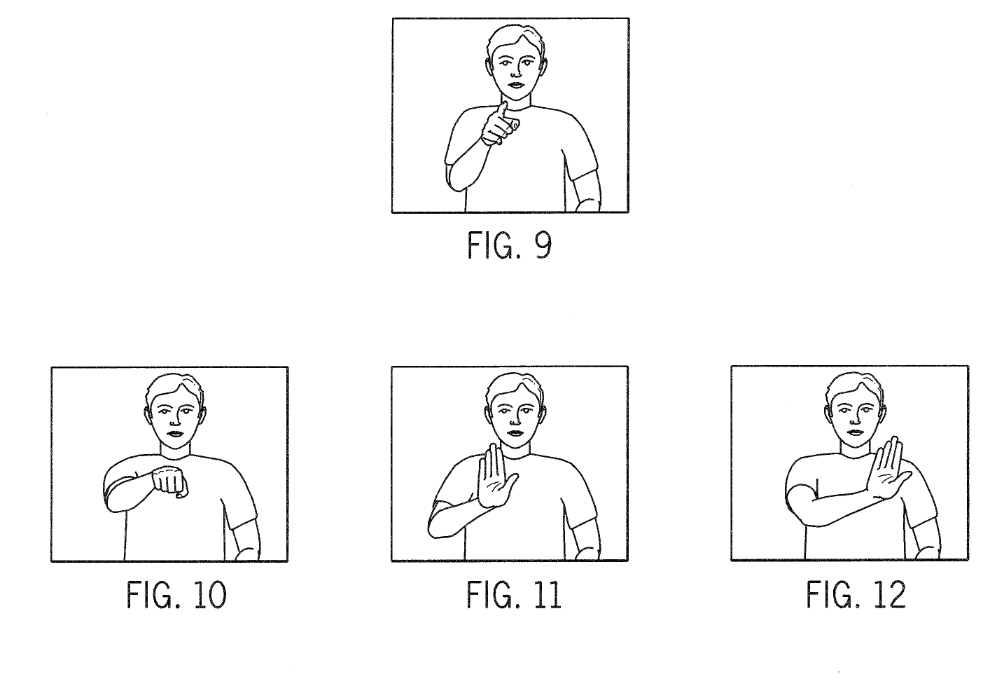

One benefit of using the hand-shaped cursor is that the user can use hand gestures in order to indicate which of the plurality of objects the user is about to manipulate using hand gestures. In some embodiments, a finger pointing action can be used to reposition the hand-shaped cursor at an appropriate location on the depicted screen displayed object. The use of a finger pointing motion is shown for example in FIG. 9. In response to such a pointing motion, the system resolves the orientation of a user's finger and creates a vector or ray from the user's finger to determine the point where the vector or ray hits on the display screen and what object is located at the point on the display screen indicated by finger pointing.

The pointing gesture may be used to indicate an on-screen button, and for pointing out an empty spot on the screen to position a newly created object. In general, the pointing action specifies a two-dimensional point on the display screen.

In addition to an object grasping, hand gesture command, an object movement hand gesture command is shown in FIGS. 3 and 4. In FIG. 3, the user's hand is shown in an initial grasping pose and then by simply moving the user's hand from right to left in this case, movement of the grasped object in the same direction, distance, and at the same speed occur on the display screen in some embodiments. Of course, in other embodiments, the setting may be used to correlate the speed, direction and extent of hand motion to its desired effect on the display screen.

Control-display (CD) gain is a coefficient that maps pointing device motion (in this case hand motion) to the movement of an on-display pointer (in this case generally a virtual hand). CD gain determines how fast a cursor moves when you move the real-world device. CDgain=velocity_pointer/velocity_device. As an example, if there is a CDgain of 5, then moving your hand 1 cm. will move the cursor 5 cm. Any CDgain value, including constant gain levels and variably adjusting gain values, may be used in some embodiments.

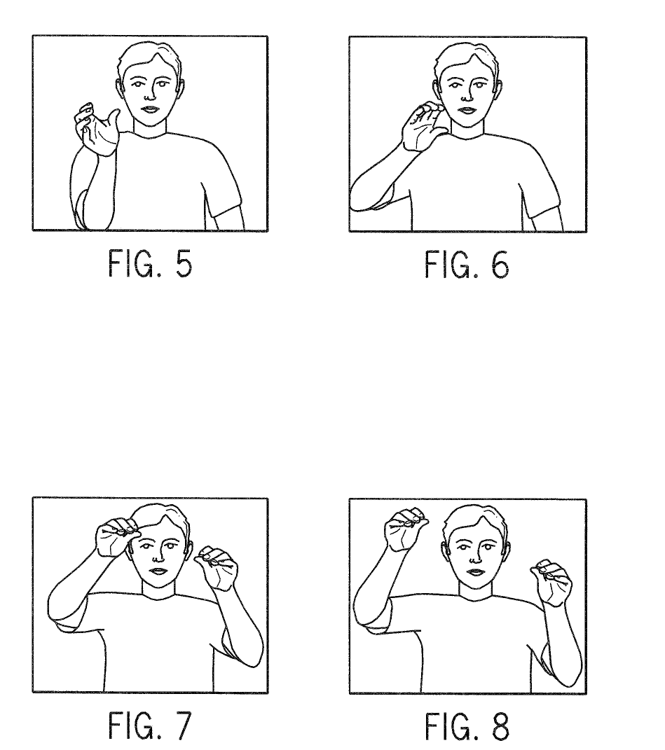

Similarly, rotary image object motion can be commanded by simply rotating the user's hand in the direction of the desired image rotation as shown in FIGS. 5 and 6.

Likewise, resizing of an object can be commanded by moving the user's hands apart as shown in FIGS. 7 and 8 to enlarge the depicted object or moving them together to shrink it. A user can then simply release an object by moving his or her fingers away from the thumb in an “opening” or “releasing” action.

Other gestures may be used for adjusting the orientation of a very large flat surface. The user may extend one or two hands with fingers curled until the virtual locations correspond to the surface location. The user then uncurls the finger so that the hands are open. Then the user can rotate the hands in any of the pitch/yaw/roll directions until the desired orientation is achieved. Once a desired orientation is achieved, the user curls his or her fingers, ending the operation.

Global gestures operate on the display screen depicted scene as a whole, as shown on the display screen, generally altering the user's view of that scene. From another perspective, these gestures alter the user's view of on-screen content of the virtual camera virtually capturing the scene. In a 3D scene, the virtual camera can be translated or the virtual camera can zoom the user's view. In a 2D scene the view can be panned or zoomed.

To simulate precise panning of an imaging device that seems to be imaging the depicted scene, the user extends the hand with fingers curled in one embodiment. The fingers are uncurled so that the hand is flat. This initiates the panning action as shown in FIGS. 10 and 11. The user then translates the hand and the system reacts by translating the view a corresponding amount. In a two-dimensional scene this translation is in two dimensions only. In a three-dimensional scene, this translation can occur in three dimensions. The operation is agnostic to hand orientation in some embodiments. The hand can be flat and facing the physical camera, the fingers can be pointed at the screen, pointed up at the ceiling or at any other orientation. The physical camera may be mounted on the display screen to image a user in front of the screen in one embodiment.

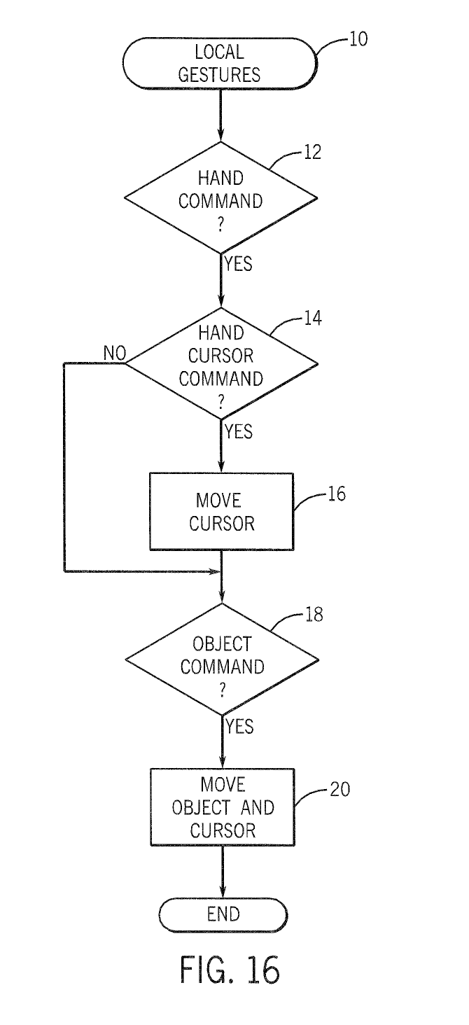

Moving on to FIG. 16, a sequence 10 may be used to implement local object based gestures such as those involving grasping, manipulating, translating or rotating depicted objects. In some embodiments, the sequence may be implemented in software, firmware and/or hardware. In software and firmware embodiments it may be implemented by computer executed instructions stored in one or more non-transitory computer readable media such as optical, magnetic or semiconductor storage.

Thus as shown in FIG. 16, a check at diamond 12 determines whether a hand gesture command has been recognized. The hand gesture commands may be trained in a training phase or may be preprogrammed. Thus only certain hand gesture commands will be recognized by the system and initially the system determines, from a video feed, whether or not a hand gesture command has been implemented. If so, a hand cursor command check occurs at diamond 14. In other words, the check at diamond 14 determines whether there is a local object manipulation type of hand gesture command that is recognized as a result of video analytics (e.g. computer vision). If so, the cursor is moved appropriately as indicated at 16 and otherwise a check at diamond 18 determines whether an object command is being suggested. If so, the object and the cursor are moved as indicated in block 20 and otherwise the flow ends.

There will be times when the hand is not in the field of view of the camera, or the computer vision algorithms may otherwise be unable to see the hand. In these cases there may generally be no hand-shaped cursor generated on the screen.

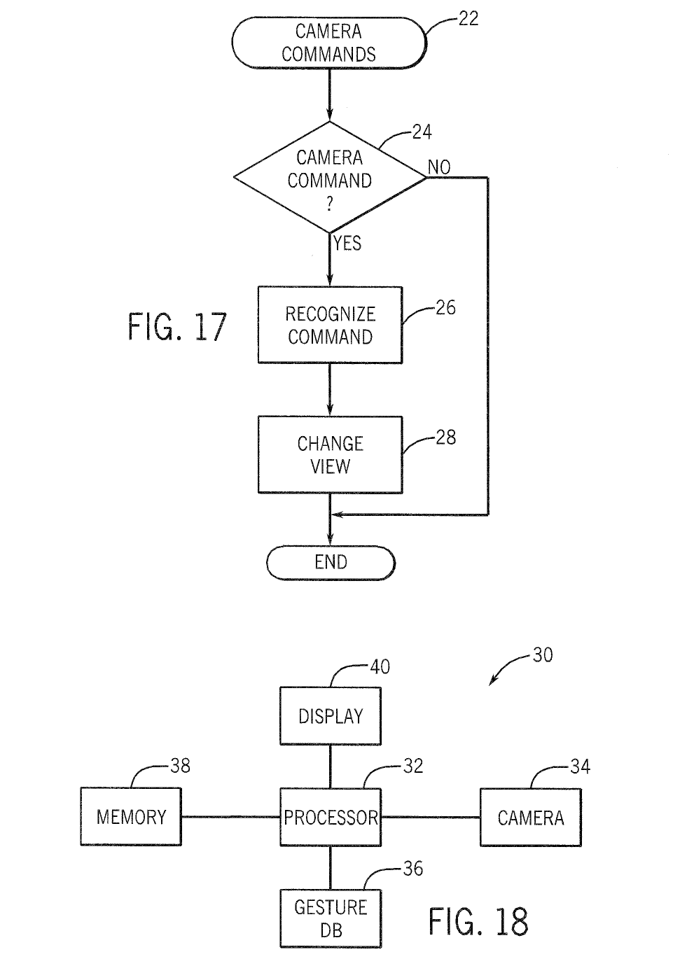

Moving on to FIG. 17, the camera command sequence 22 may be used to change the way a scene is depicted, as if the camera had been reset, moved or otherwise altered. The sequence 22 may be implemented in software, firmware and/or hardware. In software and firmware embodiments it may be implemented by computer executed instructions stored in one or more non-transitory computer readable media such as a magnetic, optical or semiconductor storage.

As shown in FIG. 17, initially a check at diamond 24 determines whether a camera type command is recognized. If so, at block 26 the particular command is identified. Then at block 28, the depiction of the view is changed correspondingly based on the type of command that was identified.

Finally, referring to FIG. 18, a system 30 is depicted. It may be any computer controlled device including a desktop computer, a laptop computer, a tablet, a cellular telephone, or a mobile Internet device, to mention some examples.

The system 30 may include a processor 32 coupled to a memory 38. In software or firmware embodiments, the memory may store the code responsible for the sequences shown in FIGS. 16 and 17. A database of gestures 32 may be provide with the system or may be learned by training the system. The training may be done by showing the system a gesture (which is recorded one or more video cameras associated with the computer) and followed by entering what command the gesture is intended to implement. This may be implemented by using a graphical user interface and software that guides the user through the training sequence.

The camera 34 may be any imaging device that is useful in depicting gestures including a depth camera. Commonly multiple cameras may be used. A display 40 is used to display the user hand gesture manipulated images.

In some embodiments, the hand gestures may be done without any initial hand orientation. Grasping, panning and zooming can be initiated from any starting hand orientation. The orientation of the hand can change dynamically during the operations, including moving an object, rotating an object, resizing an object, panning and zoom adjusting. In some embodiments the hand may be in any orientation when the operation is terminated, by either ungrasping the object or by curling the fingers for global operations.

In some embodiments, one-handed gestures can be performed with either the left or the right hands. One handed operations can be performed in parallel using both hands. For example, a user may translate one object with one hand and rotate another object with his or her other hand. This may be done by doing two different grasp operations on two different objects. Of course, if a user grasps the same object with both hands then he or she is performing a resize. Note that to perform a resize one first performs a normal grasp using one hand, at which point the user is doing a translate/rotate, but once the other hand grasps the same object, the user is doing a resize.

For two-handed gestures, or the sequence of operations matters such as when the user is grabbing an object with both hands for the resize gesture, the hand choice for the starting operating does not matter.

For many gestures, the number of extended fingers does not matter in some embodiments. For example, the pan operation can be performed with all the fingers extended or only a few. Restrictions on finger count may exist as necessary to over weigh conflict between gestures. For example, since the index finger extended is used for pointing at a two-dimensional location, it may not also be used for panning.

Hand poses similar to but different from the poses depicted herein may be used. For example, the fingers may be in a spread hand position for accurate panning or can be pressed together or fanned apart.

The parameters being adjusted by the gesture such as rotation, translation of an object or view, and zoom level can be controlled using gestures with either an absolute controlled model or a rate controlled model. In an absolute model, the magnitude to which the hand is rotated or translated and the gesture translates directly into the parameter being adjusted, namely rotation or translation. For example a 90° rotation by an input hand may result in a 90° rotation of the virtual object. In a rate controlled model, the magnitude of rotation or translation is translated into the rate of change of a parameter such as rotational velocity or linear velocity. Thus a 90° rotation may be translated into a rate of change of 10° degrees per second or some other constant rate. With the rate controlled model, if the user returns his or her hand to the starting state, the ongoing change suspends, as the rate reduces to zero. If the user releases the object at any point, the entire operation terminates, in one embodiment.

The user does not need to return the hand to the starting state to stop the ongoing change. “Starting state” may imply original location, orientation, and pose of the hand. The user only needs to open their hand from a grasp into an open hand in order for the rate controlled model adjustment to stop. The user is essentially “letting go” of the object.

Other grasping poses may also be used for object level selection. These include but are not limited to grasping between thumb and forefingers, grasping between the thumb and the index finger, and grasping within a fist.

All gestures may be subject to minimum thresholds in some embodiments for avoiding unintended actions. For example a user may have to move his or her hand more than a given amount before translation of the virtual object occurs. The threshold value can be adjusted as needed and appropriate by appropriate user inputs. Adjustment of object and view parameters can be constrained by given snap values. For example, virtual objects may be constrained to snap to a five centimeter grid, with the virtual objects stepping in five centimeter increments. Snapping between different objects can also be enforced.

Users may want to restrict manipulation along certain degrees of freedom. For example, a user may want to translate an object only along the x axis, rotate an object only around the z axis, or pan only along the y axis. However, mid-air gestures often lack the precision to make these commands easy to recognize. All the gestures described above can be restricted by rules that limit the degrees of freedom of an operation based on the user's preference or intent as determined by programmed rules. For example, if the user drags an object and the initial magnitude of the translation is almost entirely along the x axis, the system may determine that the user wants to translate only along the x axis and for the duration of this translation, that constraint is enforced. The system may judge what the user intends to indicate based on the largest magnitude change the user imparts to the object early on in a gesture sequence in one embodiment.

Of course other hand gestures can be used to provide more inputs to the system. For example, in a fast panning gesture, the user can simply swipe quickly in one direction (e.g. side to side or up and down) with some number of fingers extended. In a two-handed zoom gesture, the user can start with fisted or curled hands spaced apart and then open the hands to a flat handed position and then spread the open hands apart. Uncurling or opening the hand initiates the zoom and the moving the hands apart from one another may be done to zoom in and moving hands closer together commands a zoom out. The operation may be terminated when the user curls the fingers back into a fist.

A reset may be done by the user raising a hand and waving it back and forth. This causes the system to move up one level in a command hierarchy. It can cancel an operation, quit an application, move up one level in a navigation hierarchy, or perform some other similar action.

The following clauses and/or examples pertain to further embodiments:

One example embodiment may be a method enabling a cursor image to be moved, using only hand gestures; enabling the cursor image to be associated with an object depicted on a display screen using only hand gestures; and enabling said object to appear to move using only hand gestures. The method may also include causing a cursor image that is hand-shaped to appear to grasp an object on the display screen in response to a grasping hand motion by a user. The method may also include translating the object in response to translating hand motion. The method may also include rotating the object in response to rotating hand motion. The method may also include resizing an object in response to the user moving his or her hands apart or together. The method may also include selecting the object using a user hand grasping motion. The method may also include deselecting an object by using a user hand ungrasping motion. The method may also include selecting the object by pointing a finger at it. The method may also include using hand gestures to create one of panning or zooming effects.

Another example embodiment may be at least one or more computer readable media storing instructions executed by a computer to perform a sequence comprising moving a hand-shape cursor image, using only hand gestures, moving said image to be associated with an object depicted on a display screen using only hand gestures; and moving said depiction of said object to using only hand gestures. The media may further store instructions to perform a sequence further including causing a cursor image that is hand-shaped to appear to grasp an object on the display screen in response to a grasping hand motion by a user. The media may further store instructions to perform a sequence further including translating the object in response to translating hand motion. The media may further store instructions to perform a sequence further including rotating the object in response to rotating hand motion. The media may further store instructions to perform a sequence further including resizing an object in response to the user moving his or her hands apart or together. The media may further store instructions to perform a sequence further including selecting the object using a user hand grasping motion. The media may further store instructions to perform a sequence further including deselecting an object by using a user hand ungrasping motion. The media may further store instructions to perform a sequence further including selecting the object by pointing a finger at it. The media may further store instructions to perform a sequence further including using hand gestures to create one of panning or zooming effects.

Another example embodiment may be an apparatus comprising an image capture device; and a processor to analyze video from said device to detect user hand gestures and, using only said hand gestures to move said cursor image to engage an object depicted on a display screen and to move said depicted object. The apparatus may include a processor to cause a cursor image that is hand-shaped to appear to grasp an object on the display screen in response to a grasping hand motion by a user. The apparatus may include a processor to translate the object in response to translating hand motion. The apparatus may include processor to rotate the object in response to rotating hand motion. The apparatus may include a processor to resize an object in response to the user moving his or her hands apart or together. The apparatus may include a processor to select the object using a user hand grasping motion. The apparatus may include a processor to deselect an object by using a user hand ungrasping motion.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a cursor image to be moved, using only hand gestures;
enabling the cursor image to be associated with an object depicted on a display screen using only hand gestures; and
enabling said object to appear to move using only hand gestures.

2. The method of claim 1 including causing a cursor image that is hand-shaped to appear to grasp an object on the display screen in response to a grasping hand motion by a user.

3. The method of claim 2 including translating the object in response to translating hand motion.

4. The method of claim 2 including rotating the object in response to rotating hand motion.

5. The method of claim 1 including resizing an object in response to the user moving his or her hands apart or together.

6. The method of claim 1 including selecting the object using a user hand grasping motion.

7. The method of claim 6 including deselecting an object by using a user hand ungrasping motion.

8. The method of claim 1 including selecting the object by pointing a finger at it.

9. The method of claim 1 including using hand gestures to create one of panning or zooming effects.

10. One or more computer readable media storing instructions executed by a computer to perform a sequence comprising:
moving a hand-shape cursor image, using only hand gestures;
moving said image to be associated with an object depicted on a display screen using only hand gestures; and
moving said depiction of said object to using only hand gestures.

11. The media of claim 10 further storing instructions to perform a sequence further including causing a cursor image that is hand-shaped to appear to grasp an object on the display screen in response to a grasping hand motion by a user.

12. The media of claim 11 further storing instructions to perform a sequence further including translating the object in response to translating hand motion.

13. The media of claim 11 further storing instructions to perform a sequence further including rotating the object in response to rotating hand motion.

14. The media of claim 10 further storing instructions to perform a sequence further including resizing an object in response to the user moving his or her hands apart or together.

15. The media of claim 10 further storing instructions to perform a sequence further including selecting the object using a user hand grasping motion.

16. The media of claim 15 further storing instructions to perform a sequence further including deselecting an object by using a user hand ungrasping motion.

17. The media of claim 10 further storing instructions to perform a sequence further including selecting the object by pointing a finger at it.

18. The media of claim 10 further storing instructions to perform a sequence further including using hand gestures to create one of panning or zooming effects.

19. An apparatus comprising:
an image capture device; and
a processor to analyze video from said device to detect user hand gestures and, using only said hand gestures to move said cursor image to engage an object depicted on a display screen and to move said depicted object.

20. The apparatus of claim 19, said processor to cause a cursor image that is hand-shaped to appear to grasp an object on the display screen in response to a grasping hand motion by a user.

21. The apparatus of claim 20, said processor to translate the object in response to translating hand motion.

22. The apparatus of claim 20, said processor to rotate the object in response to rotating hand motion.

23. The apparatus of claim 19, said processor to resize an object in response to the user moving his or her hands apart or together.

24. The apparatus of claim 19, said processor to select the object using a user hand grasping motion.

25. The apparatus of claim 24, said processor to deselect an object by using a user hand ungrasping motion.
